(19) United States
(12) Patent Application Publication
(10) Pub. No.: US 2009/0046826 A1
(43) Pub. Date: Feb. 19, 2009

(54) Fuel Cladding Protective Sleeve, Method for Producing Fuel Rods and Device for Carrying out Said Method

(75) Inventors: Jean-Pierre Bariteau, Pont Saint Esprit (FR); Michel Marchand, Fontenay Le Fleury (FR)

Correspondence Address: Nixon Peabody LLP, 200 Page Mill Road, Palo Alto, CA, 94306, US

(73) Assignee: AREVA NC, Paris (FR)

(21) Appl. No.: 12/083,899

(22) PCT Filed: Oct. 16, 2006
(86) PCT No.: PCT/EP2006/067436

§ 371 Date: Apr. 17, 2008

(30) Foreign Application Priority Data
Oct. 18, 2005 (FR) 05 53155

(51) Int. Cl. G21C 3/06

(52) U.S. Cl. 376/416

(57) ABSTRACT

Method for producing fuel rods characterized in that it comprises the steps of:
a) placing a sleeve on an open end (30a) of a cladding (30), said sleeve comprising a passage provided with a shoulder designed to protect a surface of the open end (30a) of the cladding (30),
b) inserting the end of the cladding (30a) provided with the sleeve into the cladding nose,
c) isolating a space for receiving the pellets and an outer space,
d) filling the cladding with pellets,
e) interrupting said filling when the cladding contains a determined number of pellets,
f) removing the end (30a) of the cladding from the cladding nose,
g) ablating the sleeve.

Device for carrying out the method according to the invention and a protective sleeve for nuclear fuel cladding.

### TECHNICAL FIELD AND PRIOR ART

The invention concerns a fuel cladding protective sleeve, a method for producing fuel rods and a device for carrying out said method.

The principal application of this invention concerns the nuclear field and radioactive fuels.

More precisely, the invention concerns a sleeve for cladding fuel pellets in a cladding, preferably tubular and metallic.

This operation takes place at the level of a cladding nose having a through passage and whereof one of the sides sealably receives one end of the cladding and whereof the other side receives the fuel pellets, which arrive in a line in order to fill the cladding, which is later closed.

It is important to protect the space in which the cladding is found from the pollution and/or contamination which can be created by the pellets. There is also a risk of contamination of the end of the cladding through which filling is done.

To avoid risking transmission of this pollution and/or contamination into the cladding, a first step is provided involving cleaning the end of the fuel rod. This cleaning operation is done dry, by rubbing the concerned surface with a cleaning rag. This cleaning is usually done after the cladding operation (i.e. after separation of the fuel rod thus formed from the cladding nose). Then, in a second step, one cleans the outer lateral surface of the cladding.

These cleanings are done automatically and remotely. The operation is delicate and quite detailed to perform, the quality of the cleaning depending in particular on the time devoted to it.

After being filled, the fuel rod is enclosed during a plugging operation at the end of which one detects the contamination levels of the cladding: if this level is above a predetermined threshold value, an extra cleaning step is carried out, generally manually, on the fuel rod contact that is irradiating and contaminating.

It is consequently one aim of the present invention to offer a method for producing nuclear fuel rods enabling a reduction of the cleaning steps.

It is also an aim of the present invention to offer a device for producing nuclear fuel rods allowing protection of the fuel rod from contamination.

### DESCRIPTION OF THE INVENTION

The aims stated above are achieved by a production method providing for the arrangement of a protective sleeve on the open end of the cladding and the removal of this sleeve before placement of a cap.

The present invention then substantially relates to a method for producing fuel rods characterized in that it comprises the steps of:

a) arranging a protective sleeve onto the open end of a cladding, said sleeve comprising a passage provided with an inner shoulder for protecting the surface of the open end of the cladding,

b) inserting the end of the cladding provided with the sleeve into the cladding nose,

c) isolating a space receiving pellets and an outer space,

d) filling the cladding with pellets,

e) interrupting the filling when the cladding is filled with a determined number of pellets,

f) removing the end from the cladding nose,

g) ablating the sleeve.

The method according to the present invention may also include the step of placing a cap in the open end of the cladding.

During step b), drive means can be activated in order to bring the cladding towards the cladding nose until the open end of said cladding is alongside said cladding nose.

During step c), boundary means are activated so that they sealably cooperate with the entire periphery of a demarcation section of the sleeve in order to isolate said area receiving the pellets from the outer area.

During step d), supply means are activated to bring the fuel pellets into the upstream area, and means are activated for the introduction of the fuel pellets into the passage of the cladding nose until the desired quantity of fuel pellets is contained in said cladding.

During step e), the supply means and the means for the introduction of fuel pellets are deactivated.

Moreover, during step e), the drive means are activated in order to separate the cladding from the cladding nose until said cladding is located in the downstream area.

During step g), the removal means are also activated in order to separate the sleeve from the cladding, and the sleeve is discharged.

The present invention also relates to a device for producing fuel rods having a longitudinal axis with the help of a cladding and a tubular protective sleeve having a passage provided with an inner shoulder designed to protect a face of the open end of the cladding, and fuel pellets comprising:
a cladding nose having a through passage extending between an upstream side for the arrival of said fuel pellets and a downstream side, able to receive the end of the cladding provided with the sleeve,
boundary means able to cooperate with the sleeve to sealably separate the downstream area from the upstream area,
supply means able to bring said fuel pellets into said upstream area,
means for introducing the fuel pellets into the upstream side of the passage of the cladding nose and into the cladding,
retractable drive means able to cooperate with the cladding to allow movement of said cladding in the downstream area in the direction of and/or from said cladding nose between a separated position in which the cladding is outside said passage and said side-by-side position,
means for removing the protective sleeve from the cladding.

In particular, the downstream side is conformed to cooperate so as to surround a first end of the cladding, said first end of the cladding being surrounded by the sleeve, said downstream side of the passage being able to come sealably into contact with the external surface of the first end of the sleeve in a side-by-side position.

Advantageously, the cladding nose and the defining means are revolutionally symmetrical around the longitudinal axis.

Moreover, the device may comprise means for placing the sleeve around the cladding on an end section of the cladding comprising said first end.

Advantageously, the end of the passage of the cladding nose located on a side downstream from said passage has an internal surface in the shape of a truncated narrowing in the direction of the upstream side of said passage.

The device may also comprise guide means, located downstream from said defining means and making it possible to orient the movements of said cladding with respect to said downstream side of the cladding nose.

In a third embodiment, the boundary means comprise an inflatable annular seal able to surround the demarcation section of the sleeve and able to come into contact against the external surface of said demarcation section in an active position.

In one embodiment, the removal means can comprise a gripper provided with at least two parts able to squeeze the first end of the sleeve according to the present invention, and equipped with at least one radial protrusion intended to cooperate with said groove in order to hold the sleeve and separate it from the cladding via traction.

In another embodiment, the removal means comprise at least one element forming a tappet, able to surround the cladding on at least part of its contour behind the second end of the sleeve, and able to drive said sleeve by pushing, separating it from said cladding by sliding.

In a second embodiment, the boundary means comprise an annular seal housed in an annular groove located on the external surface of the first end of the sleeve.

In a third embodiment, said defining means comprise a lip seal, said lip being able to surround the demarcation section of the sleeve and able to come sealably into contact against the external surface of the demarcation section in a tightened position.

In this way, one understands that the sleeve protects the cladding throughout the entire cladding operation and that it is then removed and discharged into a waste receptacle, for later processing.

Thus, one ensures the non-pollution and/or non-contamination of the external surface of the cladding of the fuel rod simply and effectively, in a way that can be automated, while creating a minimum amount of waste.

In this way, one is freed from the previously mentioned cleaning operations and the cleaning operations which must be performed manually are minimized, these requiring the presence of operators near and/or in contact with the claddings and/or fuel rods.

Furthermore, the elimination or at least minimization of these cleaning operations leads to a significant gain in time in the production of these fuel rods.

The present invention also concerns a protective sleeve for a nuclear fuel cladding comprising a body with longitudinal axis provided with a passage, at least one part of said passage being able to cooperate sealably with a peripheral wall of a cladding, the passage comprising a first part having a smaller diameter and a second part having a larger diameter, at least one part of said second part being able to cooperate sealably with the peripheral wall of the cladding, said first and second parts connecting to each other via a shoulder, said shoulder being able to protect one surface of the open end of the cladding.

In one embodiment, the sleeve also comprises gripping means formed on an external wall of the sleeve. These means are formed, for example, by a groove.

In another embodiment, the sleeve comprises, at one end from the side of the part having the smaller diameter, a recess provided with a seal.

Advantageously, the sleeve comprises sealing flanges protruding from an internal wall of the second part having a larger diameter and able to come sealably into contact with an outer wall of the cladding.

The description below and the illustrative drawings are provided only for information and are not exhaustive.

### BRIEF DESCRIPTION OF THE DRAWINGS

Reference will be made to the appended drawings in which:

FIGS. 1 to 3 are diagrammatic elevation views of a first embodiment of a device for production according to the invention from the side and during different steps in the method for producing a fuel rod,

FIG. 4 is a detailed view of area IV of FIG. 1,

FIGS. 5 to 10 are diagrammatic elevation views of a second embodiment of a device for production according to the invention from the side and during different steps in the method for producing a fuel rod,

FIGS. 11 and 12 are detailed views similar to that of FIG. 4, illustrating different relative positions between the cladding and the cladding nose, these two figures corresponding to the initial and final positions of the step illustrated in FIG. 6, respectively,

FIG. 13 is a view similar to that of FIG. 6 for a third embodiment of a cladding assembly according to the invention,

FIG. 14a is a perspective view of a sleeve according to the present invention,

FIG. 14b is a longitudinal cross-section of FIG. 14a.

### DETAILED DESCRIPTION OF SPECIFIC EMBODIMENTS

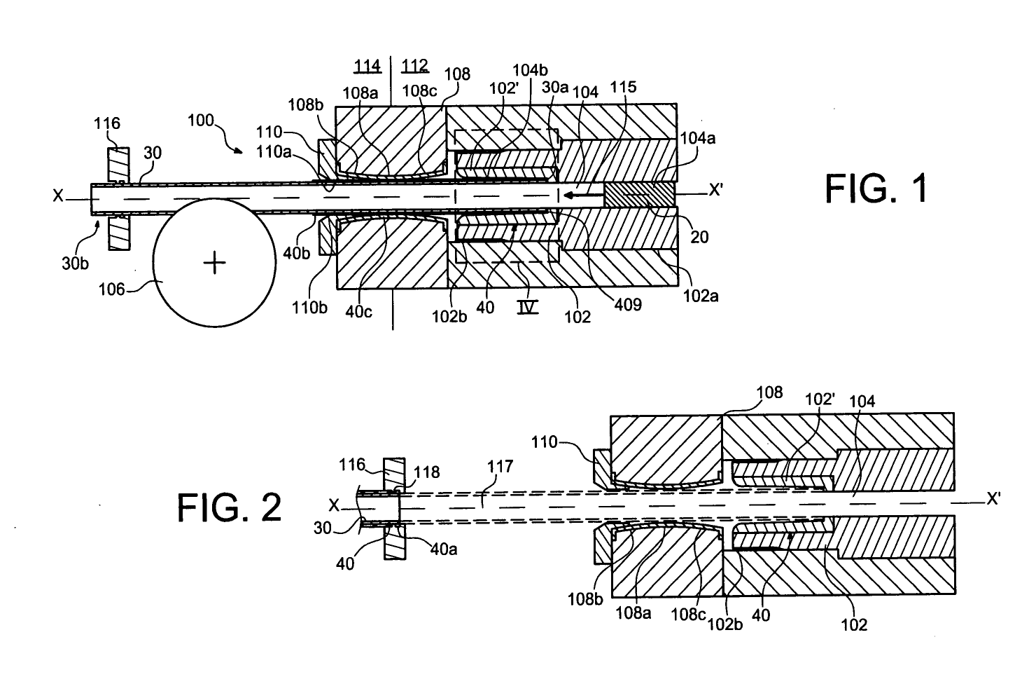

In reference to FIG. 1, a production device 100 is illustrated in a situation prior to the formation of a fuel rod.

Indeed, fuel pellets 20 are arranged in the alignment of a longitudinal axis (X, X′) around which is also placed a hollow cladding 30 intended to contain a pile of pellets 20 so as to form a fuel rod.

The cladding 30 extends between a first end 30a located on the right in FIG. 1 and a second end 30b located on the left in FIG. 1.

A sleeve 40 covers an end area of the cladding 30 which contains the first end 30a.

The cladding 30 and the sleeve 40 are revolutionally symmetrical around the axis (X, X′).

The cladding 30 is preferably formed by a metallic tube, for example, a zirconium alloy (Zircaloy).

The sleeve 40 constitutes a single-use protective element of the cladding 30, this sleeve is for instance in a relatively stiff elastomer.

In order to minimize the quantity of waste, one will seek to use a sleeve 40 having a limited length and a minimal thickness.

The sleeve 40 is mounted on the end area of the cladding 30, outside the cladding assembly 100 illustrated in FIG. 1. This operation can be done manually outside an enclosure, such as a glove box in which the fuel pellets and the rods formed later will be kept.

Mounting the sleeve 40 on the cladding 30 can also be done automatically inside or outside the glove box.

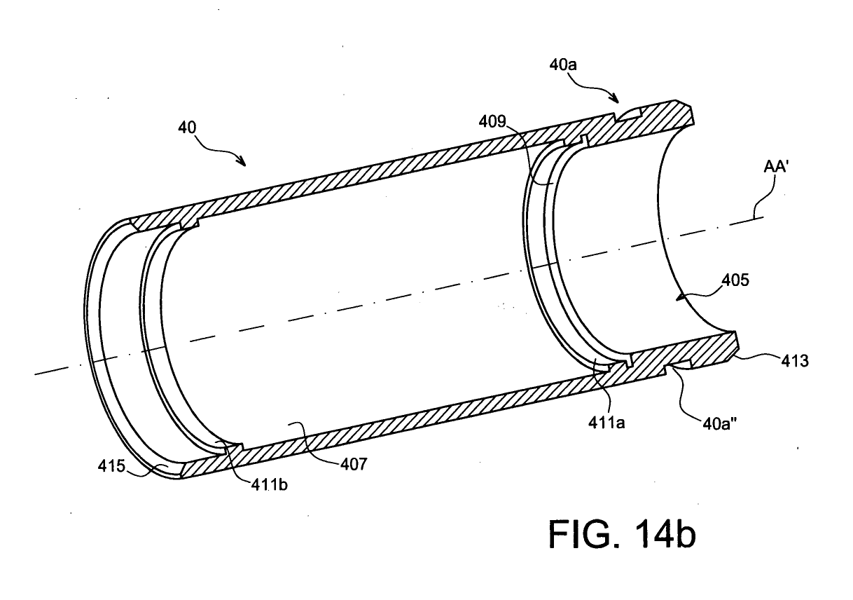

The protective sleeve 40 illustrated in FIGS. 14a and 14b comprises a body 401 having a regular cylindrical shape, having an axis A-A′, and a central passage 403 also having an axis A-A′. The passage comprises a first part having a smaller diameter 405 and a second part having a larger diameter 407, connected to each other by a shoulder 409. The shoulder 409 is intended to bear against the end 30a of the cladding 30, so as to isolate said cladding from the debris coming from the pellets when they are loaded in the cladding.

In the illustrated example and advantageously, the second part having a larger diameter 407 has a diameter greater than the external diameter of the cladding and comprises annular flanges 411 protruding from the internal wall of said second part. The flange 411b is able to come sealably into contact with the cladding, to form a barrier against contamination resulting from the passage of pellets, and ensures maintenance by elastic expansion of the sleeve on the cladding. The flange 411b guides the sleeve on the cladding.

The sleeve may comprise several flanges 411.

In the illustrated example, the sleeve comprises two flanges, but a sleeve provided with one or more than two flanges is not outside the framework of the present invention.

In the illustrated example, the flanges have a substantially rectangular cross-section, a Christmas tree-shaped cross-section or any other shape cross-section can also work.

Furthermore, the sleeve may comprise a second part having an internal diameter substantially smaller than the diameter of the cladding.

Furthermore, the first end 40a of the sleeve advantageously comprises, on its external diameter, a bevel 413 so as to facilitate its insertion in a cladding nose.

The free end of the part having the larger diameter 407 advantageously comprises a bevel 415 on its internal diameter to facilitate insertion of the cladding 30 in the sleeve 40.

In reference to FIG. 1, the cladding device 100 comprises a cladding nose 102 extending longitudinally the length of and around the axis (X, X′) between a first end 102a and a second end 102b. The cladding nose 102 has a through passage 104 extending from the first end 102a to the second end 102b. The diameter of this passage 104 is provided in order to enable the progress of the pellets 20 arriving in batches from the first end 102a, these pellets 20 being pushed using a bit (not shown) in the direction of the second end 102b.

In FIG. 1, a batch of pellets 20 is housed inside the passage 104 on the upstream side 104a located on the right in FIG. 1. From the upstream side 104a, the passage 104 is cylindrical with a circular cross-section and from the downstream side 104b, the passage 104 has a slightly flared truncated cone shape which has an increasingly large diameter in the direction of the second end 102b of the cladding nose.

This flared shape will facilitate the entry, positioning and centering of the first end 30a of the cladding 30 inside the downstream side 104b of the passage 104.

At the downstream side 104b of the passage 104, the cladding nose 102 comprises an internal part 102′ illustrated in an enlargement in FIG. 4.

If one refers to FIG. 4, this internal part 102′ surrounds the downstream side 104b of the passage 104 from a first end 104b1, having a circular cross-section with an identical diameter and aligned with the diameter of the passage 104 at the level of the upstream side 104a until the second end 104b6 of the downstream side 104b. This second end 104b6 has a circular cross-section and has a larger diameter than the diameter of the upstream side 104a of the passage 104, and is coaxial thereto.

Between the first end 104b1 and the second end 104b6 of the downstream side 104b, the passage 104 successively has a re-entrant shoulder 104b2 along a direction perpendicular to the axis (X, X′), an annular groove 104b3 open on the re-entrant shoulder 104b2, a circular section 104b4 having a larger diameter than the first end 104b1, and, over a large part of the length of the internal piece 102, a tapered section 104b5 expanding as it goes from the diameter of the circular section 104b4 to the second end 104b6.

As can also be seen in FIG. 4, the tubular cladding 30 covered with the sleeve 40 has an external diameter substantially equal to the diameter of the circular section 104b4.

Moreover, as appears in FIG. 4, the first end 40a of the sleeve 40 exceeds the first end 30a of the cladding 30. More precisely, the first end 40a of the sleeve 40 has a greater thickness corresponding to the sum of the thickness of the cladding 30 and of the second end 40b of the sleeve 40. This first end 40a of the sleeve 40 extends substantially along the circular section 104b4 and the annular groove 104b3. The surface 40a′ of the first end 40a of the sleeve 40 turned in the direction of the upstream side 104a of the passage 104 abuts against the re-entrant shoulder 104b2: in this position, as appears in FIG. 4, the circular wall of the first end of the downstream side 104b, the internal diameter of the first end 40a of the sleeve 40 and the internal diameter of the first end 30a of the cladding 30 are substantially aligned so as to reduce the risk of catching of the pellets during pellet transfer operations.

In the aforementioned position as shown in FIG. 4, the cladding 30 covered by the sleeve 40 is next to the cladding nose 102 in the passage 104.

If one refers again to FIG. 1, the cladding 30 covered by the sleeve has been brought to the side-by-side position shown in FIG. 4 using a retractable wheel 106.

Between the second end 102b of the cladding nose 102 and the second end 40b of the sleeve 40, is arranged an annular inflatable seal 108 forming a delimiter surrounding, with tight and sealable contact, a demarcation section 40c of the sleeve 40.

More precisely, the seal 108 comprises a central section 108a and two end sections 108b and 108c. The central section 108a defines a cylindrical passage having a circular cross-section which comes into sealable contact against the demarcation section 40c which is substantially the same length.

The two end sections 108b and 108c define a tapered passage which expands from the central section 108a. A system for the arrival of pressurized air (not shown) enables inflation of the seal 108 such that when the seal 108 is under pressure, i.e. in an active position, the central section 108a is in sealable contact with the external surface of the demarcation section 40c.

This active position is implemented before the arrival of the pellets 20 in the cladding nose and the seal is deactivated 108 by evacuating the pressurized air at the end of filling the cladding 30 (this position in shown in chain dotted lines in FIG. 2).

This inflatable seal 108 is preceded, from the side through which the cladding 30 arrives (on the left in FIG. 1), by an annular guide 110 having a first end 110a, provided with a circular passage and having a small thickness so as to be able to be inserted in the passage of the inflatable seal. The second end 110b of the annular guide 110 has a passage with a truncated cone shape which becomes larger in the direction opposite the nose so as to form an entry guide for the cladding 30 covered with the sleeve 40.

The guide 110 and the inflatable seal 108 separate an area 112 able to be contaminated receiving the fuel pellets 20 (on the right in FIG. 1) from an area 114 not contaminated by the pellets 20. The sleeve 40 has a length such that it extends from the re-entrant shoulder 104b2 (see FIG. 4) at least until the second end 110b of the annular guide 110. In the illustrated example, the second end 40b of the sleeve exceeds this second end 110b of the annular guide 110.

The area able to be contaminated 112, will be called the “upstream area”, while the uncontaminated area 114 will be called the “downstream area”, these areas 112 and 114 being separated from each other, in the longitudinal direction along the axis (X, X′) by the central section 108a of the inflatable seal.

The device for producing rods also comprises supply means (not shown) able to bring the columns of fuel pellets 20 into this upstream area 112.

From the situation shown in FIG. 1, the pellets 20 are introduced into the upstream side 104a of the passage 104 of the cladding nose, then the pellets 20 are pushed (see arrow 115 of FIG. 1) to the inside of the cladding 30. In this way, several columns of pellets 20 are placed end to end inside the cladding 30 so as to form a fuel rod. The capping or sealable closing of this fuel rod is not described.

The position of FIG. 1 is illustrated, in dotted lines in FIG. 2. In the illustration of FIG. 2, the wheel 106 is retracted, i.e. it is removed so as to avoid its potential contamination.

The second end 30b of the cladding 30 is grabbed by a handling gripper (not shown). Then, the cladding 30 is separated from the cladding nose 102, the seal 108 and the guide 110 (see arrow 117 in FIG. 2) until it arrives at the separated position of the cladding 30 which is illustrated in solid lines in FIG. 2.

In this separated position, a gripper 116 is opened and placed around the first end 40a of the sleeve 40; this gripper 116 is then closed around this first end 40a.

The inner contour of the gripper 116 has a shape that is complementary with the outer contour of the first end 40a of the sleeve 40 (see FIGS. 14a and 14b). In particular, the gripper 116 comprises a rib 118 which can be housed in a corresponding groove 40a″, or advantageously annular groove of the external surface of the first end 40a of the sleeve 40.

The rib 118 is annular or not. More generally, the gripper 116 is provided with at least one radial protrusion designed to cooperate with the groove 40a″ to hold the sleeve 40 and separate it via traction from the cladding 30, itself held by the aforementioned handling gripper.

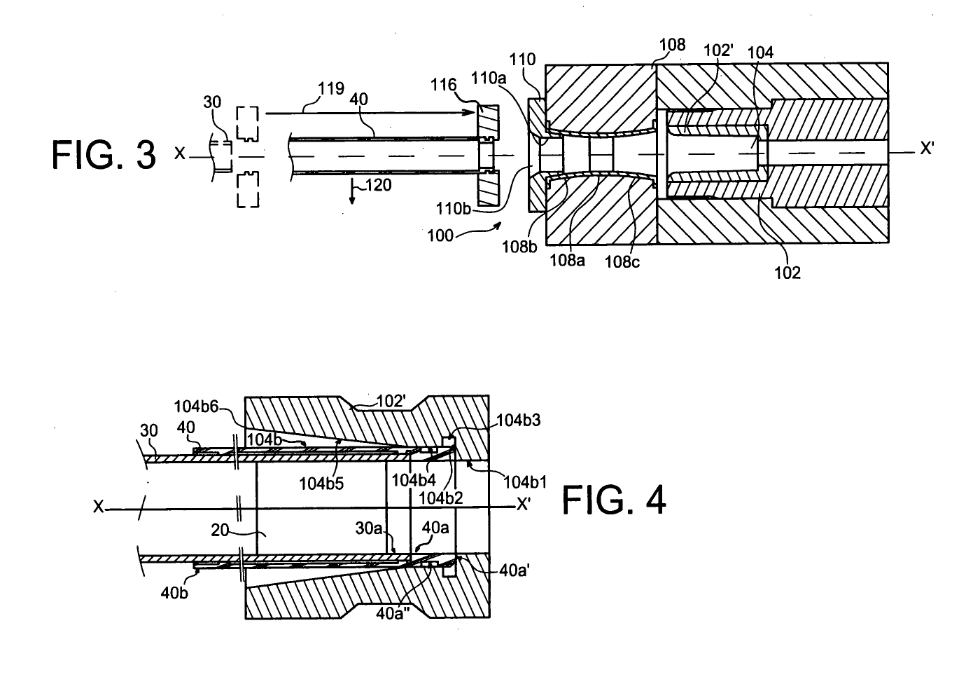

In this position illustrated in FIG. 2, in which the gripper 116 is tightened around the first end 40a of the sleeve 40 (situation in dotted lines in FIG. 3), one advances the gripper 116 in the direction of the cladding nose 102 (see arrow 119): the sleeve 40 having served during filling of the cladding 30 by the pellets 20, is now separated from the cladding 30.

After this separation operation, the gripper 116 is opened, such that the sleeve 40 falls (see arrow 120) gravitationally into a waste receptacle (not illustrated) provided for this purpose.

The open gripper 116 will return to its initial position shown in FIG. 1 while waiting for the arrival of another cladding 30.

Thus, one understands that the entire part of the cladding 30 located in the upstream area 112 was protected from any contamination by the pellets 20 via the sleeve 40 which is then separated from the cladding 30 then evacuated: one thus manages simply and effectively to protect the outer surface of the cladding 30 of the fuel rod from all pollution and/or contamination during the cladding operation.

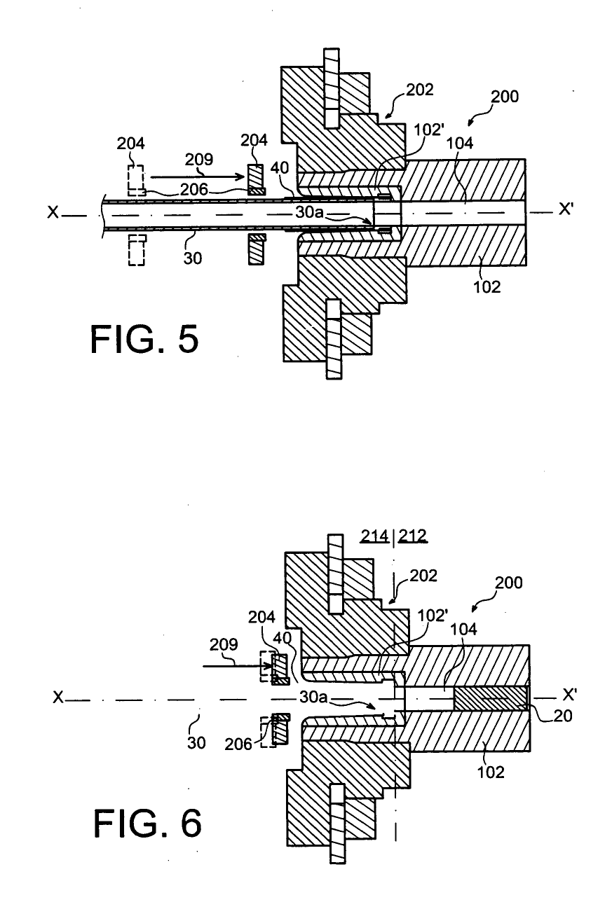

We will now refer to FIGS. 5 to 10, illustrating a second embodiment of the device bearing the general reference 200. The elements of the cladding assembly shared by the first embodiment 100 and the second embodiment 200 bear the same numerical references relative to the preceding description of the first embodiment.

The device 200 according to the second embodiment comprises a cladding nose 102 which is surrounded by different assembly elements generically designated by reference 202.

Similar assembly elements can be mounted around the cladding nose 102 in the case of the first embodiment of the device for fuel rod production 100 even if they are not shown in FIGS. 1 to 3.

The device 200 does not have the seal 108, guide 110 and gripper 116 of the first embodiment. The cladding 30 covered by the sleeve 40 is advanced into the cladding nose 102 using the drive wheel 106 and the side-by-side position is achieved using a tappet element 204 as will be described below in relation to FIGS. 5 and 6.

The element forming the tappet 204 is formed by two half-shells able to surround at least part of the circular contour of the external surface of the cladding 30, a stiff radially-internal part 206 in compression forming a sealable contact.

This radially internal part 206 of the tappet element 204 can be made in a material such as an elastomer, which advantageously makes it possible to avoid any risk of scratching the cladding.

When the drive wheel 106 has brought the first end 30a of the cladding 30 to the inside of the passage 104, the tappet element 204, which is open, goes from a back position illustrated in dotted lines in FIG. 5, to a front position illustrated in solid lines in FIG. 5 by coming closer to the sleeve 40 along the direction of the arrow 209.

The tappet element 204 is then closed so as to be tightened around the external surface of the cladding 30 (step illustrated in dotted lines in FIG. 6).

The tappet element 204 is then advanced (arrow 209 in FIG. 6) along the cladding 30 until it abuts against the second end 40b of the sleeve 40.

The tappet element 204 continuing to advance along the direction of the arrow 209 while being tightened around the cladding 30, one arrives at the arrangement of FIG. 4 in which the cladding 30 is alongside the bottom of the cladding nose 102.

It is in this side-by-side position illustrated in FIG. 6 and corresponding to the position of FIG. 1 of the first embodiment, that filling of the cladding 30 by the fuel pellets 20 is done in order to form a fuel rod.

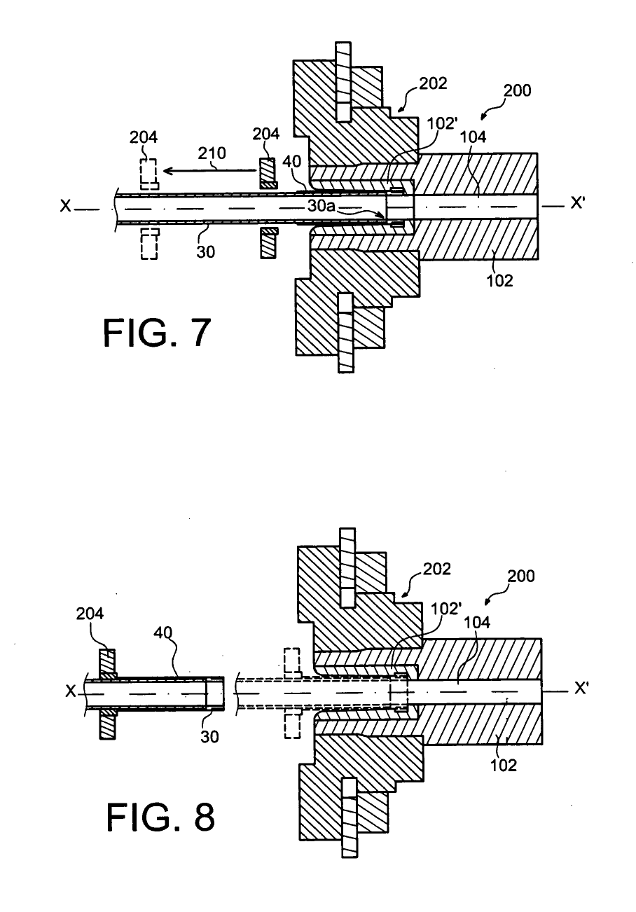

After this cladding operation of the pellets has been carried out, as illustrated in FIG. 7 in dotted lines, the tappet element 204 is opened while moving radially away from the cladding 30, then it is separated from the nose 102 in the longitudinal direction in the direction of the arrow 210.

From the position of the cladding in FIG. 7 or that shown in dotted lines in FIG. 8, the separation between the cladding 30 and the cladding nose 102 takes place similarly to that described in relation to FIG. 2 using a handling gripper of the capping station to arrive at the position illustrated in solid lines in FIG. 8.

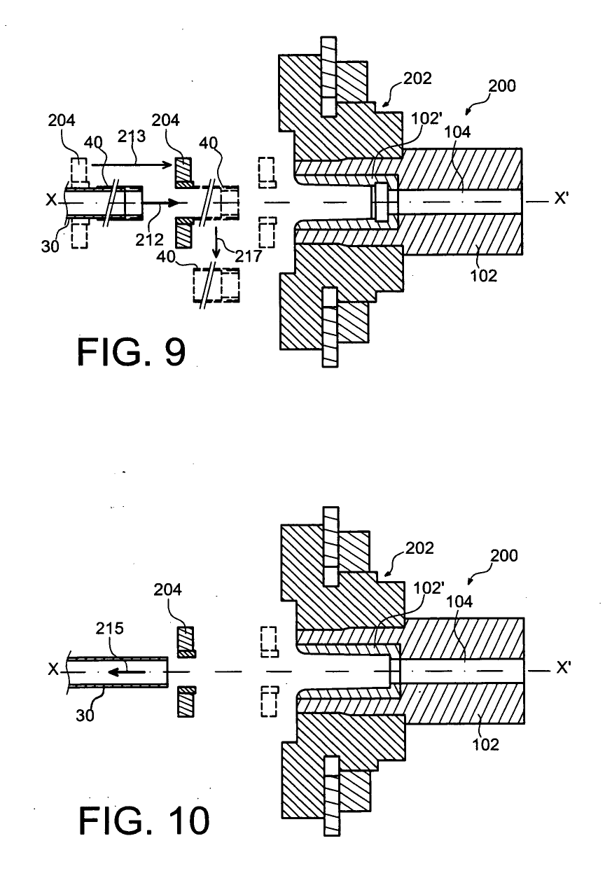

One then closes the tappet element 204 by tightening around the cladding 30, the tappet element 204 is advanced in the direction of the cladding nose 102 (see arrow 213 in FIG. 9) while thus removing the sleeve 40 from the cladding 30, which remains in the separated position. The movement of the sleeve 40 leads to its total separation (position illustrated in dotted lines in FIG. 9) from the cladding 30 to finish by a gravitational fall (arrow 217) of the sleeve 40 in the direction of a waste receptacle previously mentioned.

The tappet element 204 is then radially opened (see FIG. 10) and the cladding 30, full of fuel pellets 20, is separated from the device 200 (see arrow 215) in the direction of the capping station.

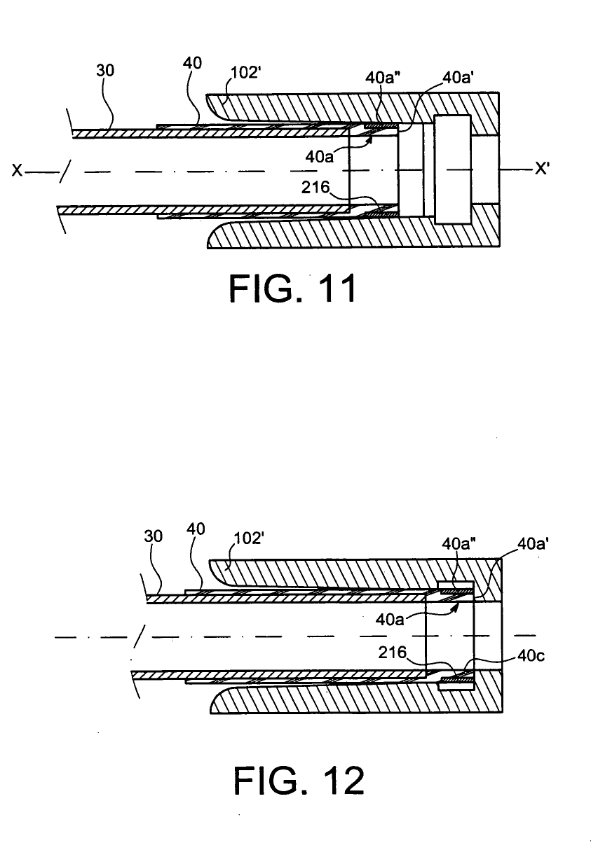

In FIGS. 11 and 12 are shown, enlarged, certain relative positions between the cladding 30 covered by the sleeve 40 and the internal part 102′ of the cladding nose 102.

More specifically, FIG. 11 corresponds to the front position from FIG. 5 and FIG. 12 corresponds to the side-by-side position illustrated in FIG. 6 and which was illustrated in FIG. 4 in relation to the first embodiment.

Only the first end 40a of the sleeve 40 was modified in relation to the scenario of the first embodiment: the groove 40a″ extends until the surface 40a′ and it is equipped with an annular elastomer seal 216 designed to limit the risks of contamination of the passage 104 at the internal part 102 of the cladding nose 102, when the fuel pellets 20 are arranged inside the cladding 30.

In the second embodiment, the seal 216 defines (see FIG. 6) the upstream area 212 able to be contaminated from the downstream area 214 and the tappet element 204 plays the same handling role as the gripper 116 of the first embodiment.

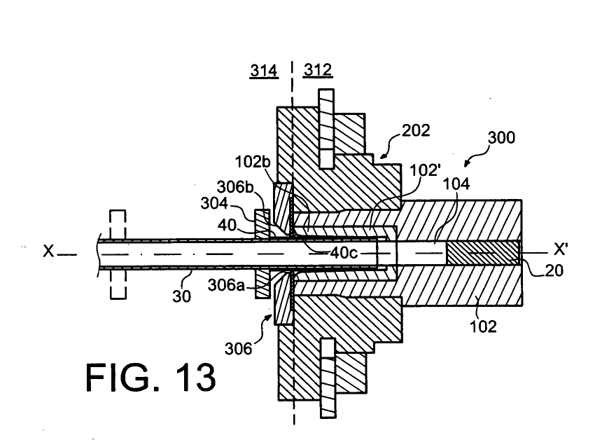

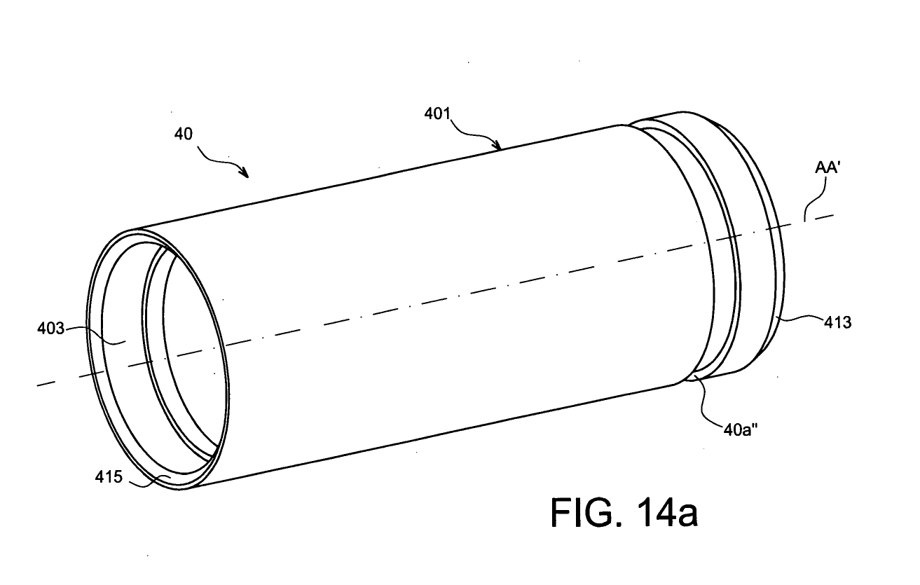

The third embodiment of the production device illustrated in relation to FIG. 13 and having the numerical reference 300 is distinguished from the second embodiment in that the tappet element 204 is replaced by a tappet element 304 and a lip seal 306.

In this case, the tappet element 304 does not comprise the radially internal part 206 in contact with the external surface of the cladding 30 but it is made in only one piece.

This tappet element 304 is operated completely identically to the tappet element 204 according to FIGS. 5 to 10.

The lip seal 306 is arranged adjacent to the second end 102b of the cladding nose with a lip able to come into sealable contact and tightened against the external surface of the sleeve 40 at the site of the demarcation section.

Preferably, as illustrated in FIG. 13, the lip 306a is arranged longitudinally as close as possible to the second end 102b of the cladding nose at the level of a first end of the lip seal 306.

In the case of the third embodiment, it is the lip 306a of the lip seal 306 which separates the upstream area 312 from the downstream area 314.

The second end 306b of the lip seal 306 has a tapered opening widening from the first end 306a, in order to facilitate entry of the cladding 30 in the direction of the cladding nose 102.

With regard to the relative arrangement between the first end 40a of the sleeve and the downstream side 104b of the passage, FIGS. 11 and 12 remain valid in the framework of the third embodiment except for the seal 216, which is then optional.

As shown by the three embodiments previously illustrated and described, the sleeve 40 surpasses substantially to the right, i.e. from the first end 30a of the cladding 30.

1. A method for producing fuel rods characterized in that it comprises the steps of:
a) placing a sleeve on an open end of a cladding, said sleeve comprising a passage provided with internal shoulder designed to protect a surface of the open end of the cladding,
b) inserting the end of the cladding provided with the sleeve in the cladding nose,
c) isolating a space receiving pellets and an outer space,
d) filling the cladding with pellets,
e) interrupting said filling when the cladding contains a determined number of pellets;
f) removing the end from the cladding of the cladding nose,
g) ablating the sleeve.

2. The method according to claim 1, also comprising the step of placing a cap in the end of the cladding.

3. The method for producing fuel rods according to claim 1, in which, during step b), drive means are activated in order to bring said cladding towards said cladding nose until the first end of said cladding comes alongside said cladding nose.

4. The method according to claim 1, in which during step c), boundary means are activated so that they cooperate sealably with the entire periphery of a demarcation section of the sleeve to separate the upstream area from the downstream area.

5. The method according to claim 1, in which during step d), supply means are activated to bring said fuel pellets into said upstream area, and means are activated for introducing said fuel pellets into the passage of said cladding nose until the desired quantity of fuel pellets is contained in said cladding.

6. The method according to claim 5, in which during step e), the supply means and the means for introducing fuel pellets are deactivated.

7. The method according to claim 3, in which during step e), the drive means are activated in order to separate the cladding from the cladding nose until said cladding is located in the downstream area.

8. The method according to claim 1, in which during step g), removal means are activated in order to separate the sleeve from the cladding, and said sleeve is discharged.

9. A device for producing fuel rods having a longitudinal axis, with the help of a cladding and a tubular protective sleeve comprising a passage provided with an inner shoulder designed to protect a surface of the open end of the cladding, and fuel pellets comprising:
a cladding nose with a through passage extending between an upstream side for arrival of said fuel pellets and a downstream side, able to receive the end of the cladding provided with the sleeve,
delimiter able to cooperate with the sleeve to sealably separate the downstream area from the upstream area,
supplier able to bring said fuel pellets into said upstream area,
means for introducing said fuel pellets into the upstream side of the passage of the cladding nose and into the cladding,
retractable drive means able to cooperate with said cladding to allow movement of said cladding in said downstream area in the direction of and/or from said cladding nose between a separated position in which the cladding is outside said passage and said side-by-side position,
removal means for removing the sleeve from the cladding.

10. The device according to claim 9, in which the downstream side of the passage of the sleeve is conformed to cooperate so as to surround a first end of said cladding, said first end of the cladding being surrounded by the sleeve, the downstream side of the passage being able to bear against the external surface of the first end of said sleeve in a side-by-side position.

11. The device according to claim 9, in which said cladding nose and said delimiter are revolutionally symmetrical around the longitudinal axis.

12. The device according to claim 9, also comprising means for placing said sleeve around said cladding on an end section of the cladding comprising the first end.

13. The device according to claim 9, in which the end of the passage of the cladding nose located from the downstream side of the passage has an internal surface in the shape of a truncated cone narrowing in the direction of the upstream side of said passage.

14. The device according to claim 9, furthermore comprising guide means located downstream from said delimeter and making it possible to orient the movements of said cladding with respect to the downstream side of the cladding nose.

15. The device according to claim 9, in which the delimiter comprises an inflatable annular seal able to surround the demarcation section of the sleeve and able to come into contact against the external surface of said demarcation section in an active position.

16. The device according to claim 9, in which the removal means comprise a gripper provided with at least two parts able to grip said first end of the sleeve provided with a groove formed in its external wall, and equipped with at least one radial protrusion designed to cooperate with said groove to hold said sleeve and separate it from the cladding via traction.

17. The device according to claim 9, said removal means comprising at least one tappet element able to surround said cladding over at least one part of its contour behind the second end of said sleeve, and able to drive said sleeve by pushing while separating it from the cladding via sliding.

18. The device according to claim 9, in which the delimiter comprises an annular seal housed in an annular groove located on the external surface of the first end of the sleeve.

19. The device according to claim 9, in which the delimiter comprises a lip seal, said lip being able to surround the demarcation section of the sleeve and able to come into sealable contact against the external surface of the demarcation section in a tightened position.

20. A protective sleeve for nuclear fuel cladding, designed to be inserted between the cladding and a cladding nose of a device for producing nuclear fuel rods, said sleeve comprising a body having a longitudinal axis provided with a passage, at least one part of said passage being able to cooperate sealably with a peripheral wall of a cladding, the passage comprising a first part of smaller diameter and a second part of larger diameter, at least one part of said second part being able to cooperate sealably with the peripheral wall of the cladding, said first and second parts being connected to each other by a shoulder designed to protect a surface of an open end of the cladding, the sleeve being in one piece and the first part of smaller diameter having a diameter substantially equal to the internal diameter of the cladding nose.

21. The sleeve according to claim 20, also comprising gripper formed on the outer wall of the sleeve.

22. The sleeve according to claim 21 in which the gripper is formed by a groove.

23. The sleeve according to claim 20, comprising at one end of the side of the part having the smaller diameter, a recess provided with a seal.

24. The sleeve according to claim 20, comprising sealing flanges protruding from an inner wall of the second part having a larger diameter and able to come into sealable contact with an outer wall of the cladding.
